(19) United States
(12) Patent Application Publication
(10) Pub. No.: US 2019/0070894 A1
(43) Pub. Date: Mar. 7, 2019

(54) VEHICLE WHEEL

(71) Applicant: HONDA MOTOR CO., LTD., Tokyo (JP)

(72) Inventors: Youichi KAMIYAMA, Wako-shi, Saitama (JP); Katsushi ISHII, Wako-shi, Saitama (JP)

(21) Appl. No.: 16/084,759

(22) PCT Filed: Mar. 16, 2017
(86) PCT No.: PCT/JP2017/010792

§ 371 Date: Sep. 13, 2018

(30) Foreign Application Priority Data
Mar. 16, 2016 (JP) 2016-052107

(51) Int. Cl. B60B 21/12; B60B 21/02; B60R 13/08; G10K 11/172

(52) U.S. Cl. CPC B60B 21/12; B60B 21/023; B60B 2900/133; B60R 13/0884; G10K 11/172; B60B 21/026

(57) ABSTRACT

Provided is a vehicle wheel capable of improving sound deadening property by increasing a capacity of an auxiliary air chamber member without impairing an assembling property of a tire. An upper surface portion of a width-direction cross-section of an auxiliary air chamber member includes a first side wall portion and a second side wall portion which extend radially outwardly. The upper surface portion further includes a curved portion having a convex shape. The curved portion is connected to the first side wall portion and the second side wall portion at connection points. As a result, the curved portion is configured to have a convex shape projecting outwardly in a radial direction.

### TECHNICAL FIELD

The present invention relates to a vehicle wheel.

### BACKGROUND ART

A vehicle wheel provided with an auxiliary air chamber member for sound absorption (muffling) is known. As a conventional auxiliary air chamber member, an auxiliary air chamber member is known, which includes a main body portion fitted between a first vertical wall surface and a second vertical wall surface of a wheel, a first edge portion extending from the main body portion toward the first vertical wall surface, and a second edge portion extending from the main body portion toward the second vertical wall surface, wherein a length in a width direction of one edge portion is shorter than that in the width direction of the other edge portion (for example see Patent Document 1).

### CITATION LIST

### Patent Literature

Patent Document 1: Japanese Patent Application Publication No. 2014-226990

### SUMMARY OF INVENTION

### Technical Problem

However, in such a conventional auxiliary air chamber member, when an internal capacity is increased in order to improve sound deadening property, an external size is large, and it interferes with a bead portion of a tire at the time of assembly. Therefore, it has been difficult to further increase the capacity in the auxiliary air chamber member without sacrificing an assembling property of the tire. An object of the present invention is to provide a vehicle wheel capable of improving sound deadening property by maximizing the capacity of the auxiliary air chamber member without impairing the assembling property of the tire.

### Solution to Problem

A vehicle wheel according to the present invention is a vehicle wheel including an auxiliary air chamber member as a Helmholtz resonator on an outer peripheral surface of a well portion in a tire air chamber, wherein the auxiliary air chamber member includes: a lower surface portion disposed on the outer peripheral surface side; and an upper surface portion disposed radially outward of the lower surface portion, and the upper surface portion in a width direction cross-section includes: a first side wall portion and a second side wall portion extending radially outwardly; and a curved portion which connects the first side wall portion and the second side wall portion and has a convex shape projecting radially outwardly.

According to the present invention, the curved portion connecting the first side wall portion and the second side wall portion has a convex shape. Therefore, the capacity of the auxiliary air chamber member can be set to be increased. Further, rigidity of the curved portion is improved, so that deformation of the upper surface portion when a centrifugal force is applied to the wheel can be reduced. Therefore, it is possible to prevent the upper surface portion from being deformed to reduce the capacity of the auxiliary air chamber member by the curved portion having a convex shape.

Further, the auxiliary air chamber member may include one side end portion and the other side end portion, and the upper surface portion is located radially inward of an imaginary line passing through a first top portion of a first hump portion and a second top portion of a second hump portion out of two hump portions sandwiching the well portion. Therefore, even when the curved portion has a convex shape, it is possible to improve the sound deadening property of the auxiliary air chamber member by reducing contact with the auxiliary air chamber member at the time of mounting the tire and without impairing the assembling property of the tire.

Further, the auxiliary air chamber member may include one side end portion and the other side end portion, the well portion may include a projecting portion where the one side end portion of the auxiliary air chamber member is locked in the middle in a width direction of the well portion, and when a top portion of a hump portion closer to the other side end portion out of two hump portions is defined as a first top portion and a top portion of the projecting portion is defined as a third top portion, a first connecting portion connecting one side of the curved portion and the first side wall portion, and a second connecting portion connecting the other side of the curved portion and the second side wall portion are arranged on an imaginary line passing through the first top portion and the third top portion or radially inward of the imaginary line. Therefore, it is possible to further reduce the contact with the auxiliary air chamber member at the time of mounting the tire and to improve the sound deadening property of the auxiliary air chamber member.

Further, the curved portion may be formed with a single arc. Therefore, further stress concentration hardly occurs in the upper surface portion, and desired rigidity for maintaining a volume of the auxiliary air chamber can be easily obtained.

Further, the curved portion may be formed by connecting a plurality of arcs. Therefore, it is possible to improve the rigidity while securing the volume of the auxiliary air chamber.

Further, the curved portion may partially include a straight portion, and thus it is possible to ensure a relatively large volume of the auxiliary air chamber.

Further, a radius of curvature of the arc of the curved portion of the auxiliary air chamber member is set to be longer than a distance between a first connecting portion and a second connecting portion. Therefore, the desired rigidity can be given to the upper surface portion while securing the volume of the auxiliary air chamber.

### Advantageous Effects of Invention

According to the present invention, it is possible to provide a vehicle wheel capable of improving sound deadening property by increasing a capacity of an auxiliary air chamber member without impairing an assembling property of a tire.

### BRIEF DESCRIPTION OF DRAWINGS

FIG. 1 is a perspective view for explaining a structure of a vehicle wheel;

FIG. 2 is a cross-sectional view taken along a line II-II in FIG. 1 in the vehicle wheel of Example 1;

FIG. 3 is a cross-sectional view for explaining a structure of an essential portion of an auxiliary air chamber member of Example 2 in the vehicle wheel of the present embodiment;

FIG. 4 is a cross-sectional view taken along a line II-II in FIG. 1 in the vehicle wheel of Example 3;

FIG. 5 is a cross-sectional view of an essential portion showing an upper surface shape of the auxiliary air chamber member formed of a single arc in the vehicle wheel of Modification 1;

FIG. 6 is a cross-sectional view of the essential portion showing the upper surface shape of the auxiliary air chamber member formed by connecting a plurality of arcs in the vehicle wheel of Modification 2;

FIG. 7 is a cross-sectional view of the essential portion showing the upper surface shape of the auxiliary air chamber member formed by connecting a straight line and the arc in the vehicle wheel of Modification 3; and

FIG. 8 is a cross-sectional view showing the upper surface shape of the auxiliary air chamber member in the vehicle wheel of Modification 4.

### DESCRIPTION OF EMBODIMENTS

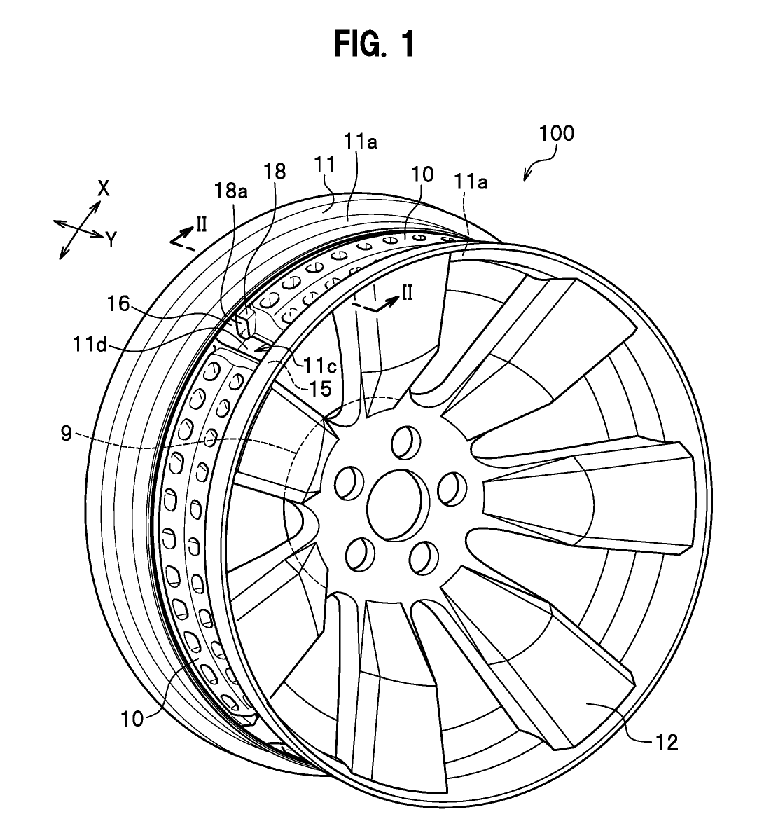

Embodiments of the present invention will be described in detail with reference to FIGS. 1 to 8. In the description, the same elements are denoted by the same reference numerals, and redundant description will be omitted. When a direction is described, it will be described based on the front, rear, left, right, up and down seen from a driver of a vehicle. A vehicle width direction and a left-right direction are synonymous.

As shown in FIG. 1, a vehicle wheel 100 according to an embodiment of the present invention has an auxiliary air chamber member (Helmholtz auxiliary air chamber member) 10 for muffling road noise caused by air column resonance in a tire air chamber MC, on an outer peripheral surface 11d of a well portion 11c. After describing an entire structure of the vehicle wheel 100, the auxiliary air chamber member 10 will be described in detail below.

FIG. 1 is a perspective view of the vehicle wheel 100 according to the embodiment of the present invention. As shown in FIG. 1, the vehicle wheel 100 includes a rim 11 and a disk 12 for connecting the rim 11 to a hub 9.

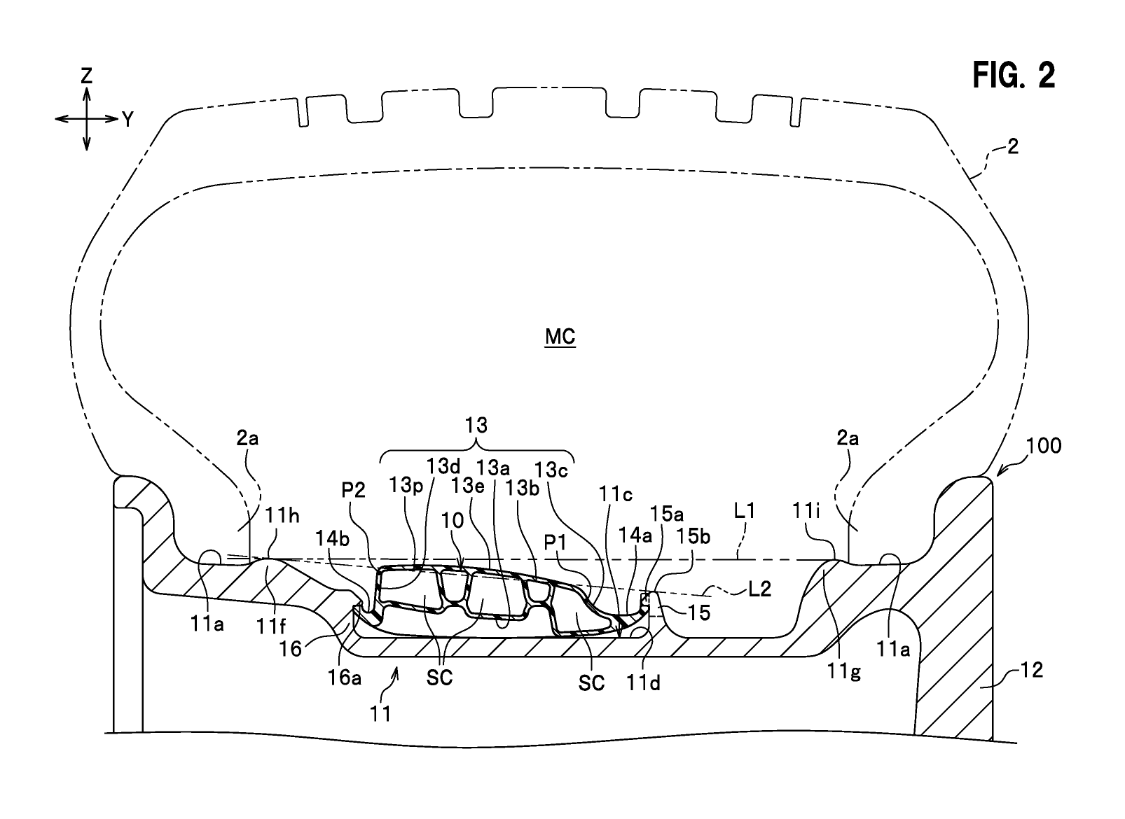

The rim 11 has a well portion 11c recessed inward in a wheel radial direction (toward a center of rotation) between bead seats 11a, 11a formed at both end portions in a wheel width direction Y of a tire shown in FIG. 1 (See FIG. 2).

The well portion 11c is provided for fitting a bead portion (see FIG. 2) of the tire thereto at the time of rim assembling for assembling the tire (not shown) to the rim 11. Incidentally, the well portion 11c in the present embodiment is formed in a cylindrical shape having substantially the same diameter across the wheel width direction Y.

In FIG. 1, the reference numeral 11d denotes the outer peripheral surface of the well portion 11c. Reference numerals 15, 16 are annular vertical wall portions provided on the outer peripheral surface 11d of the well portion 11c so as to extend in a circumferential direction of the rim 11. Among them, a vertical wall portion 15 as a projecting portion is positioned in the middle in a width direction of the well portion 11c.

Both side edges of the auxiliary air chamber member 10 are engaged with the vertical wall portions 15, 16, and the auxiliary air chamber member 10 is fitted into the well portion 11c. Reference numeral 18 denotes a pipe body in which a communication hole 18a is formed, and the pipe body 18 communicates with a hollow portion in the auxiliary air chamber member 10.

### Example 1

Next, a structure of the auxiliary air chamber member 10 of Example 1 will be described. FIG. 2 is a cross-sectional view taken along a line II-II in FIG. 1 in the vehicle wheel 100 mounted with a tire 2. The auxiliary air chamber member 10 is made of an elongated resin material and includes a hollow body portion 13 having an auxiliary air chamber SC therein and edge portions 14a, 14b positioned at both ends in the wheel width direction Y of the body portion 13.

The auxiliary air chamber member 10 is curved in a longitudinal direction thereof and attached in a wheel circumferential direction X when attached to the outer peripheral surface 11d of the well portion 11c (see FIG. 1).

The auxiliary air chamber member 10 includes a lower surface portion 13a disposed on the outer peripheral surface 11d side and an upper surface portion 13b disposed radially outward of the lower surface portion 13a. The upper surface portion 13b in a cross-section in a width direction of the auxiliary air chamber member 10 includes a first side wall portion 13c and a second side wall portion 13d which extend radially outwardly.

Further, the upper surface portion 13b includes a convex shaped curved portion 13e. The curved portion 13e is connected to the first side wall portion 13c and the second side wall portion 13d at connection points P1 and P2. Thus, the curved portion 13e is configured to have a convex shape outward in a radial direction Z.

In the vehicle wheel 100 according to the present embodiment, the curved portion 13e is arranged so that a head top portion 13p which is the highest between the connection points P1 and P2 is radially inward of an imaginary line L1. The curved portion 13e is formed in a shape slanting downward with a large curvature from the head top portion 13p so as to draw a half parabola toward the outer peripheral surface 11d of the well portion 11c.

Further, in the vehicle wheel 100 of the present embodiment, bead sheets 11a, 11a and hump portions 11f, 11g of the bead sheets 11a, 11a are integrally formed to protrude on both sides of the well portion 11c. The upper surface portion 13b is disposed on the imaginary line L1 connecting a first top portion 11h of the hump portion 11f and a second top portion 11i of the hump portion 11g or radially inward of the imaginary line L1. An imaginary line L2 passing through the first top portion 11h of the hump portion 11f and a third top portion 15b of the vertical wall portion 15 will be described in detail in Example 2.

Next, operation and effect of the auxiliary air chamber member 10 of the vehicle wheel 100 of Example 1 will be described. In the auxiliary air chamber member 10 of the vehicle wheel 100 of Example 1, the curved portion 13e connecting the first side wall portion 13c and the second side wall portion 13d between the connection points P1 and P2 is formed in a convex shape.

The curved portion 13e is disposed radially inward of the imaginary line L1 connecting the first top portion 11h of the hump portion 11f and the second top portion 11i of the hump portion 11g formed in the bead sheets 11a and 11a. Therefore, when the tire 2 is mounted on the vehicle wheel 100, even when a bead portion 2a of the tire 2 is mounted by fitting it into the well portion 11c, it does not interfere with the auxiliary air chamber member 10. Therefore, it is possible to prevent damage due to contact with the auxiliary air chamber member 10, so that an assembling property of the tire is not impaired.

Further, a capacity of the auxiliary air chamber SC can be increased by forming the curved portion 13e in a convex shape. Further, rigidity in an in-plane/out-of-plane direction of the upper surface portion 13b is increased. Therefore, it is possible to prevent the upper surface portion 3b from being deformed when an internal pressure acts, and thus it is possible to prevent reduction of the capacity of the auxiliary air chamber SC.

In the vehicle wheel 100 of Example 1, the rigidity can be increased as compared with a case where the upper surface portion 13b is formed in a flat surface shape. Therefore, it is possible to reduce deformation of the upper surface portion 13b when a centrifugal force is applied to the vehicle wheel 100. Therefore, in the vehicle wheel 100 of Example 1, the capacity of the auxiliary air chamber member 10 can be increased without impairing the assembling property of the tire and reduction in capacity due to the deformation can be prevented, so that sound deadening property can be improved.

### Example 2

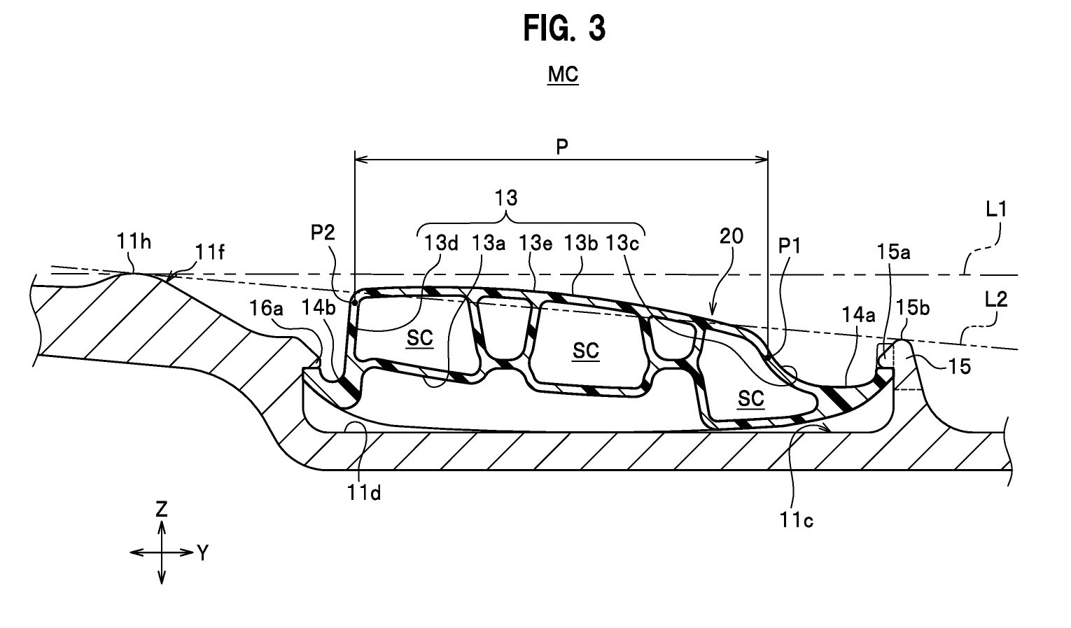

FIG. 3 is a cross-sectional view for explaining a structure of an essential portion of an auxiliary air chamber member 20 of Example 2 in the vehicle wheel of the present embodiment. The same or equivalent portions as those of the embodiment and Example 1 are denoted by the same reference numerals and described. The well portion 11c of Example 2 is also provided with the vertical wall portion 15 as a projecting portion where a part of the auxiliary air chamber member 10 is engaged.

Further, the auxiliary air chamber member 20 of Example 2 has a first connection point P1 as a first connecting portion connecting the curved portion 13e and the first side wall portion 13c, and a second connection point P2 as a second connecting portion connecting the curved portion 13e and the second side wall portion 13d. The connection points P1 and P2 are arranged radially inward of the imaginary line L2 passing through the first top portion 11h of the hump portion 11f and the third top portion 15b of the vertical wall portion 15.

Next, the function and effect of the vehicle wheel of Example 2 will be described. In the auxiliary air chamber member 20 of the vehicle wheel of Example 2, the curved portion 13e is disposed along the imaginary line L2 connecting the first top portion 11h of the hump portion 11f formed in the bead seat 11a and the third top portion 15b of the vertical wall portion 15, and is disposed radially inward of the imaginary line L1.

Further, in the auxiliary air chamber member 20 of Example 2, the connection points P1 and P2 are arranged radially inward of the imaginary line L1 connecting the first top portion 11h of the hump portion 11f and the second top portion 11i of the hump portion 11g formed in the bead seat 11a. Therefore, even when the curved portion 13e has a convex shape, it is possible to reduce contact with the upper surface portion 13b of the auxiliary air chamber member 20 at the time of mounting the tire, thereby improving the assembling property of the tire.

As described above, the vehicle wheel of Example 2 can increase the capacity of the auxiliary air chamber member 20 without impairing the assembling property of the tire, thereby improving the sound deadening property. Since other structures, operation and effect are the same as or equivalent to those of Example 1 of the embodiment, description thereof will be omitted.

### Example 3

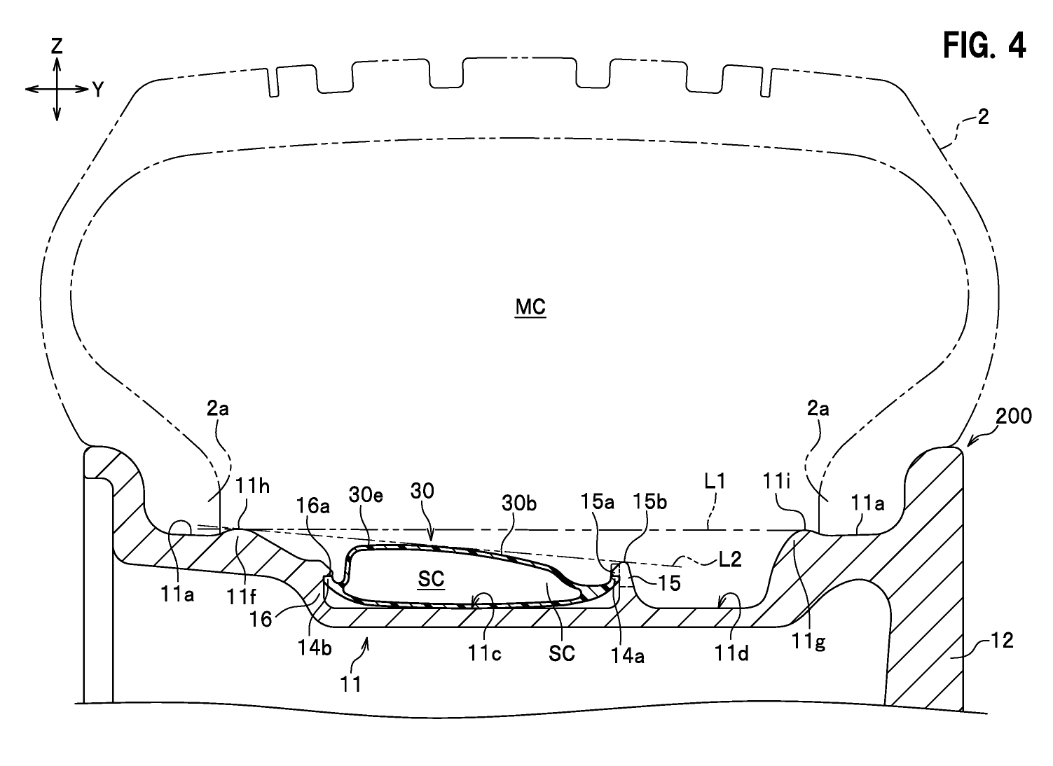

FIG. 4 is a cross-sectional view for explaining a structure of an essential portion of an auxiliary air chamber member 30 of Example 3 in the vehicle wheel of the present embodiment. The same or equivalent portions as those of the auxiliary air chamber members 10 and 20 of the above embodiment, Examples 1 and 2 are denoted by the same reference numerals and described.

In the rim 11 of a vehicle wheel 200 of Example 3, a first hump portion 11f and a second hump portion 11g are formed with the auxiliary air chamber member 30 therebetween. The first hump portion 11f and the second hump portion 11g respectively have a first top portion 11h and a second top portion 11i. An upper surface portion 30b including a curved portion 30e of the auxiliary air chamber member 30 is configured to be located radially inward of the imaginary line L1 connecting the first top portion 11h and the second top portion 11i.

Furthermore, in Example 3, the curved portion 30e constituting the upper surface portion 30b is disposed radially inward of the virtual line L2 passing through the first top portion 11h of the hump portion 11f and the third top portion 15b of the vertical wall portion 15. Thus, in addition to the operation and effect of Examples 1 and 2, in the vehicle wheel of the third embodiment, when the bead portion 2a is fitted into the well portion 11c, the bead portion 2a of the tire 2 passes radially outward of the imaginary lines L1 and L2. Therefore, the tire 2 does not interfere with the auxiliary air chamber member 30 so that the damage can be reliably prevented. As a result, it is possible to further provide the convex shaped curved portion 30e on the upper surface portion 30b without impairing the assembling property of the tire, thereby improving the rigidity.

Since other structures, operation and effect are the same as or equivalent to those of Examples 1 and 2 of the embodiment, the description thereof will be omitted.

### [Modification 1]

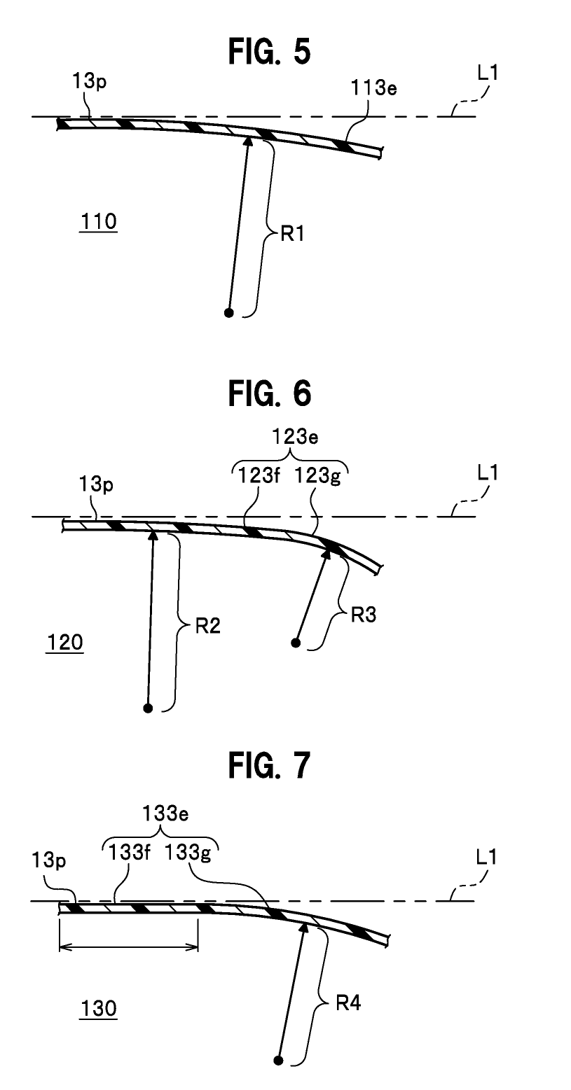

FIG. 5 is a cross-sectional view for explaining a structure of an essential portion of an auxiliary air chamber member 110 of Modification 1 in the vehicle wheel of the present embodiment. The same or equivalent portions as those of the embodiment and Example 1 are denoted by the same reference numerals and described.

In the vehicle wheel of Example 1, as shown in FIG. 2, the curved portion 13e of the auxiliary air chamber member 10 is formed in a shape slanting downward with a large curvature from the top portion 13p so as to draw a half parabola toward the outer peripheral surface 11d of the well portion 11c.

In contrast, in Modification 1, a curved portion 113e of the auxiliary air chamber member 110 is constituted by a single arc having a relatively large radius R1. The curved portion 113e is formed in a shape slanting downward from the head top portion 13p with a large curvature. Therefore, stress concentration hardly occurs, and desired rigidity can be easily obtained.

Since other structures, operation and effect are the same as or equivalent to those of Examples 1 to 3 of the above-described embodiment, the description thereof will be omitted.

### [Modification 2]

FIG. 6 is a cross-sectional view for explaining a structure of an essential portion of an auxiliary air chamber member 120 of Modification 2 in the vehicle wheel of the present embodiment. The same or equivalent portions as those of the embodiment and Example 1 are denoted by the same reference numerals and described.

In Modification 2, a curved portion 123e of the auxiliary air chamber member 120 is configured to have an arc 123f having a relatively large radius R2 and an arc 123g having a relatively small radius R3 (R2>R3). The curved portion 123e slants downward from the head top portion 13p with the arc 123f having the large curvature, and is smoothly connected to the arc 123g having the small curvature.

The curved portion 123e configured in this way is formed by a plurality of continuous arcs. Therefore, it is possible to further improve the rigidity of the upper surface portion while securing a volume of the auxiliary air chamber SC.

Since other structures, operation and effect are the same as or equivalent to those of Examples 1 to 3 of the above-described embodiment, the description thereof will be omitted.

### [Modification 3]

FIG. 7 is a cross-sectional view for explaining a structure of an essential portion of an auxiliary air chamber member 130 of Modification 3 in the vehicle wheel of the present embodiment. The same or equivalent portions as those of the embodiment and Example 1 are denoted by the same reference numerals and described.

In Modification 3, a curved portion 133e of the auxiliary air chamber member 130 is configured to have a straight portion 133f and an arc 133g having a radius R4. The curved portion 133e is continuous to the straight portion 133f extending from the head top portion 13p, to be smoothly connected to the arc 133g.

Since the curved portion 133e configured in this way has a straight portion 133f as a part thereof, it is possible to maximize the volume of the auxiliary air chamber SC within a range not interfering with the tire.

Since other structures, operation and effect are the same as or equivalent to those of Examples 1 to 3 of the above-described embodiment, the description thereof will be omitted.

### [Modification 4]

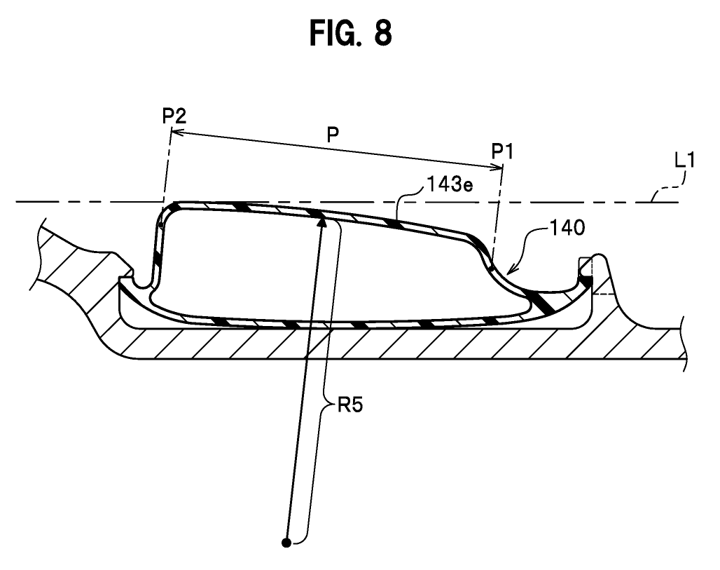

FIG. 8 is a cross-sectional view for explaining a structure of an essential portion of an auxiliary air chamber member 140 of Modification 4 in the vehicle wheel of the present embodiment. The same or equivalent parts as those of the embodiment and Example 1 are denoted by the same reference numerals and described.

In Modification 4, a radius of curvature R5 of an arc of a curved portion 143e of the auxiliary air chamber member 140 is set longer than a distance P (see FIG. 3) between the connection point P1 as the first connecting portion and the connection point P2 as the second connecting portion (R5>P). Therefore, the desired rigidity can be given to the curved portion 143e constituting the upper surface portion while securing the volume of the auxiliary air chamber SC.

Since other structures, operation and effect are the same as or equivalent to those of Examples 1 to 3 of the above-described embodiment, the description thereof will be omitted. As described above, in Examples 1 to 3 and Modifications 1 to 4 of the embodiment of the present invention, the curved portion 13e and the like are configured to have a convex shape projecting radially outwardly. Therefore, the curved portion 13e has a certain rigidity in the in-plane/out-of-plane direction, so that the deformation can be prevented.

The curved portion 13e is disposed radially inwardly of the imaginary line L1 connecting the first top portion 11h of the hump portion 11f and the second top portion 11i of the hump portion 11g, so that interference with the auxiliary air chamber member can be prevented when the tire 2 is mounted on the vehicle wheel. Therefore, it is possible to obtain a practically useful operational effect that the sound deadening property can be improved by increasing the capacity of the auxiliary air chamber member 20 without impairing the assembling property of the tire.

Although the vehicle wheel according to the present embodiment has been described in detail with reference to the drawings, the present invention is not limited to these embodiments, but can be appropriately changed without departing from the spirits and scope of the present invention.

For example, in the present embodiment, the curved portion 13e is disposed radially inwardly of the imaginary line L1 connecting the first top portion 11h of the hump portion 11f and the second top portion 11i of the hump portion 11g formed in the bead sheets 11a, 11a. However, the present invention is not limited to this, but the curved portion 13e may be disposed on the imaginary line L1 connecting the first top portion 11h of the hump portion 11f and the second top portion 11i of the hump portion 11g as long as the curved portion 13e has a convex shape projecting radially outwardly so as not to interfere with the bead portion of the tire.

In Modifications 2 and 3 shown in FIGS. 6 and 7, the arc 123f is continuous to the arc 123g or the straight portion 133f is continuous to the arc 133g, but it is not limited thereto. For example, a plurality of arcs and a plurality of linear portions may be combined, and the order of combinations and individual lengths may also be set and arranged in any way.

### [Summary of Structure and Effect]

As described above, in the vehicle wheel of the present embodiment, a vehicle wheel capable of performing analysis stably in a short time is provided.

### REFERENCE SIGNS LIST

2: tire
2a: bead portion
3b, 13b, 30b: upper surface portion
10, 20, 30, 110, 120, 130, 140: auxiliary air chamber member (resonator)
11c: well portion
11f: first hump portion
11g: second hump portion
11h: first top portion
11i: second top portion
13: body portion
13c: first side wall portion
13d: second side wall portion
13e: curved portion
15: vertical wall portion (projecting portion)
16: vertical wall portion
15b: third top portion
30e, 113e, 123e, 133e, 143e: curved portion
123f, 123g, 133g: arc
133f: straight portion
100, 200: vehicle wheel
MC: tire air chamber
P1, P2: connection point

1. A vehicle wheel comprising an auxiliary air chamber member as a Helmholtz resonator on an outer peripheral surface of a well portion in a tire air chamber, wherein
the auxiliary air chamber member comprises:
a lower surface portion disposed on the outer peripheral surface side; and
an upper surface portion disposed radially outward of the lower surface portion, and
the upper surface portion in a width direction cross-section comprises:
a first side wall portion and a second side wall portion extending radially outwardly; and
a curved portion which connects the first side wall portion and the second side wall portion and has a convex shape projecting radially outwardly.

2. The vehicle wheel according to claim 1, wherein
the auxiliary air chamber member comprises one side end portion and the other side end portion, and
the upper surface portion is located radially inward of an imaginary line passing through a first top portion of a first hump portion and a second top portion of a second hump portion out of two hump portions sandwiching the well portion.

3. The vehicle wheel according to claim 1, wherein
the auxiliary air chamber member comprises one side end portion and the other side end portion,
the well portion comprises a projecting portion where the one side end portion of the auxiliary air chamber member is locked in the middle in a width direction of the well portion, and
when a top portion of a hump portion closer to the other side end portion out of two hump portions is defined as a first top portion and a top portion of the projecting portion is defined as a third top portion, a first connecting portion connecting one side of the curved portion and the first side wall portion, and a second connecting portion connecting the other side of the curved portion and the second side wall portion are arranged on an imaginary line passing through the first top portion and the third top portion or radially inward of the imaginary line.

4. The vehicle wheel according to claim 1, wherein the curved portion is formed with a single arc.

5. The vehicle wheel according to claim 2, wherein the curved portion is formed with a single arc.

6. The vehicle wheel according to claim 3, wherein the curved portion is formed with a single arc.

7. The vehicle wheel according to claim 1, wherein the curved portion is formed by connecting a plurality of arcs.

8. The vehicle wheel according to claim 2, wherein the curved portion is formed by connecting a plurality of arcs.

9. The vehicle wheel according to claim 3, wherein the curved portion is formed by connecting a plurality of arcs.

10. The vehicle wheel according to claim 1, wherein the curved portion is formed by partially connecting a straight line to an arc.

11. The vehicle wheel according to claim 2, wherein the curved portion is formed by partially connecting a straight line to an arc.

12. The vehicle wheel according to claim 3, wherein the curved portion is formed by partially connecting a straight line to an arc.

13. The vehicle wheel according to claim 4, wherein a radius of curvature of the arc is set to be longer than a distance between a first connecting portion connecting one side of the curved portion and the first side wall portion, and a second connecting portion connecting the other side of the curved portion and the second side wall portion.

14. The vehicle wheel according to claim 5, wherein a radius of curvature of the arc is set to be longer than a distance between a first connecting portion connecting one side of the curved portion and the first side wall portion, and a second connecting portion connecting the other side of the curved portion and the second side wall portion.

15. The vehicle wheel according to claim 6, wherein a radius of curvature of the arc is set to be longer than a distance between a first connecting portion connecting one side of the curved portion and the first side wall portion, and a second connecting portion connecting the other side of the curved portion and the second side wall portion.

16. The vehicle wheel according to claim 7, wherein a radius of curvature of the arc is set to be longer than a distance between a first connecting portion connecting one side of the curved portion and the first side wall portion, and a second connecting portion connecting the other side of the curved portion and the second side wall portion.

17. The vehicle wheel according to claim 8, wherein a radius of curvature of the arc is set to be longer than a distance between a first connecting portion connecting one side of the curved portion and the first side wall portion, and a second connecting portion connecting the other side of the curved portion and the second side wall portion.

18. The vehicle wheel according to claim 9, wherein a radius of curvature of the arc is set to be longer than a distance between a first connecting portion connecting one side of the curved portion and the first side wall portion, and a second connecting portion connecting the other side of the curved portion and the second side wall portion.

19. The vehicle wheel according to claim 10, wherein a radius of curvature of the arc is set to be longer than a distance between a first connecting portion connecting one side of the curved portion and the first side wall portion, and a second connecting portion connecting the other side of the curved portion and the second side wall portion.

20. The vehicle wheel according to claim 11, wherein a radius of curvature of the arc is set to be longer than a distance between a first connecting portion connecting one side of the curved portion and the first side wall portion, and a second connecting portion connecting the other side of the curved portion and the second side wall portion.

21. The vehicle wheel according to claim 12, wherein a radius of curvature of the arc is set to be longer than a distance between a first connecting portion connecting one side of the curved portion and the first side wall portion, and a second connecting portion connecting the other side of the curved portion and the second side wall portion.
